(19) United States
(12) Patent Application Publication
(10) Pub. No.: US 2009/0180140 A1
(43) Pub. Date: Jul. 16, 2009

(54) INFORMATION PROCESSING APPARATUS, PRINT SETTING METHOD, AND STORAGE MEDIUM

(75) Inventor: Nobuhiro Kawamura, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/350,807

(22) Filed: Jan. 8, 2009

(30) Foreign Application Priority Data
Jan. 10, 2008 (JP) 2008-003269

(51) Int. Cl. G06F 3/12

(52) U.S. Cl. 358/1.15

(57) ABSTRACT

An information processing apparatus that communicates with a printer and makes print settings of a printer driver, where the information processing apparatus includes an elimination unit configured to eliminate a conflict state occurring between a plurality of print settings set for the printer driver based on a state of at least one parameter associated with the plurality of print settings and a conflict condition which can define two print settings, where the conflict condition is set for the plurality of print settings in advance.

### BACKGROUND OF THE INVENTION

1. Field of the Invention

The present invention relates to print setting processing performed by an information processing apparatus configured to display a user interface provided to make print settings of a printer through a printer driver.

2. Description of the Related Art

A commonly used print system includes a host computer and a printer.

For performing printing based on data-for-printing transmitted from the host computer in the above-described print system, a printer driver installed in the host computer is executed so that printing suitable for the specifications of the printer is performed.

Usually, the printer driver presents a user interface (UI) referred to as a print dialog box, accepts data on setting values prepared for setting items via the print dialog box, the setting-value data being transmitted from a user, and generates print data based on the above-described setting values.

Here, some items of setting items that can be set on the print dialog box presented by the UI have exclusion relations and/or dependence relations with each other.

Therefore, the printer driver evaluates the relationships between input setting values and other setting items one after another and eliminates a conflict (mismatch) occurring between the setting items, so as to reduce the conflict (refer to Japanese Patent Laid-Open No. 2002-202868, for example).

On the other hand, CUPS Printing System operating on Mac OS® X of Apple Inc. of the US can describe a conflict condition as below. More specifically, the condition of a conflict occurring between the setting items can be described in the form of UI Constraints in a PPD file in which functions unique to a printer and/or settable choices are described.

Here, the term “UI Constraints” of the PPD file corresponds to PostScript Printer Description, and the term “CUPS” corresponds to Common UNIX® Printing System.

The above-described OS itself eliminates conflicts occurring between the setting items.

For example, when the user selects the borderless sheet size in the state where the sheet type for which borderless printing is not permitted is set, the OS evaluates the condition of a conflict occurring between the setting items based on the UI Constraints described in the PPD file. Then, the OS changes the value of the sheet type to a selectable value based on the evaluation result.

Thus, the printer driver is notified of the value corresponding to the setting item changed by the OS. Therefore, the printer driver can update the UI based on the value obtained through the notification.

### SUMMARY OF THE INVENTION

For example, the present invention provides an information processing apparatus that communicates with a printer and makes print settings of a printer driver, the information processing apparatus including an elimination unit configured to eliminate a conflict state occurring between a plurality of print settings set for the printer driver, based on a state of at least one parameter associated with the plurality of print settings and a conflict condition which can define two print settings, where the conflict condition is set for the plurality of print settings in advance.

Further features and aspects of the present invention will become apparent from the following description of exemplary embodiments with reference to the attached drawings.

### BRIEF DESCRIPTION OF THE DRAWINGS

FIG. 1 is a block diagram illustrating the configuration of a print system according to an embodiment of the present invention.

FIG. 2 shows an exemplary PPD file stored in external storage shown in FIG. 1.

FIG. 3 shows an exemplary print dialog box presented by a printer driver installed in the external storage shown in FIG. 1.

FIG. 4 shows part of the rules of selectable/unselectable combinations of print setting items provided on the print dialog box shown in FIG. 3 (conflict rules).

FIG. 5A shows an exemplary virtual UI parameter and exemplary UI Constraints that can be referred to by the OS of a host computer according to the above-described embodiment.

FIG. 5B shows an exemplary table showing the correspondences between the selectable/unselectable combinations of setting values and virtual UI parameters.

FIG. 6 shows exemplary virtual UI parameters and exemplary UI Constraints that can be referred to by the OS of the host computer according to the above-described embodiment.

FIG. 7 is a flowchart showing the first exemplary data processing procedures performed in the host computer according to the above-described embodiment.

FIG. 8 shows an exemplary print dialog box displayed on a display device shown in FIG. 1.

FIG. 9 is a flowchart showing the second exemplary data processing procedures performed in the host computer according to the above-described embodiment.

FIG. 10 shows exemplary print dialog box displayed on the display device shown in FIG. 1.

FIG. 11 illustrates the memory map of a storage medium storing various types of data processing programs that can be read by the host computer according to another embodiment of the present invention.

### DESCRIPTION OF THE EMBODIMENTS

Next, embodiments of the present invention will be described with reference to the attached drawings. First, preconditions will be described. According to the specifications of a given operating system (OS) (e.g., Mac OS X (trademark) of Apple Inc.), the description method of UI Constraints, which is an exemplary conflict condition, allows for prohibiting a combination of two setting items. However, it is difficult for the above-described method to describe that complicated a combination of three or more setting items are prohibited.

Therefore, according to the specifications of a known PostScript printer description (PPD) file, UI Constraints are not described at all in the PPD file when there is a complicated combination of three or more print setting items, where a single print setting item may have an effect on the PPD file. Thus, in a case where there is a complicated combination of three or more print setting items, each of the conflicts may be eliminated in the printer driver.

For eliminating the above-described conflicts, each of the print setting items should be handled in the printer driver. However, the implementation of the handling function is complicated.

Further, in actuality, setting items managed on the OS side are also provided on a print dialogue, the handling function may be implemented under the restrictions of the specifications of conflict conditions set on the OS side.

In that case, when setting items managed on the printer-driver side have exclusion relations and/or dependence relations with the setting items managed on the OS side, it is difficult for the printer driver to receive a notification that a setting value managed on the OS side is changed unless the UI Constraints are described. Thus, the preconditions have been described. The system configuration will be described as below.

### <Description of System Configuration>

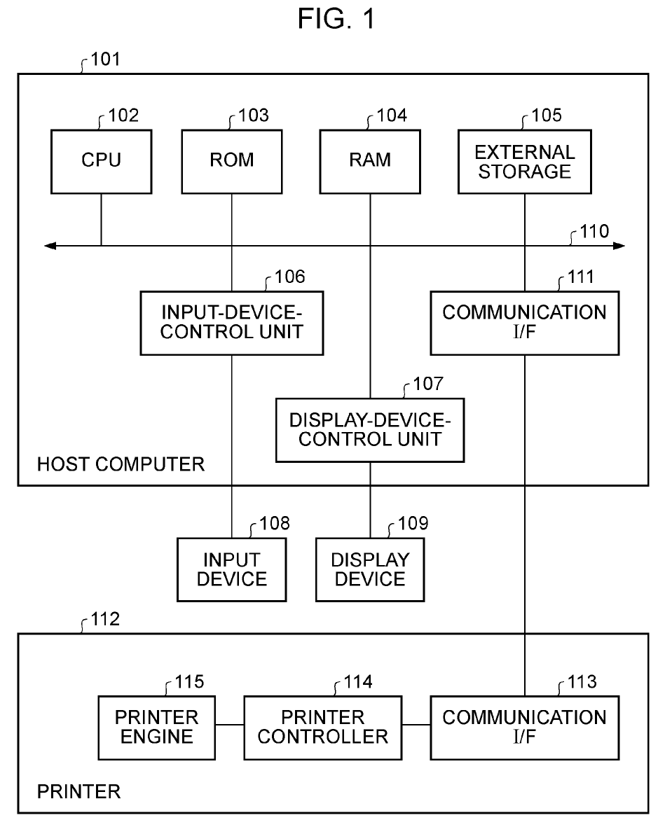

FIG. 1 is a block diagram illustrating the configuration of a print system according to a first embodiment of the present invention. The first embodiment shows an exemplary print system in which bidirectional communications can be established between a host computer 101 and a printer 112. The host computer 101 is an exemplary information processing apparatus.

According to the first embodiment, it is configured that the OS can determine the states of conflicts occurring between the print setting items managed by the OS by using the UI Constraints described in the PPD file, as described later.

Further, according to the first embodiment, it is configured that the printer driver controls the state of the print setting items displayed on a UI screen image that will be described later based on the print setting items managed by the OS and those managed by the printer driver. Here, the printer driver has a dialog display function, so as to display a print dialog box that will be described later under the control of the CPU 102. Consequently, the print setting items can be grayed out for display, so as to allow and/or not to allow for setting the display of the print setting items.

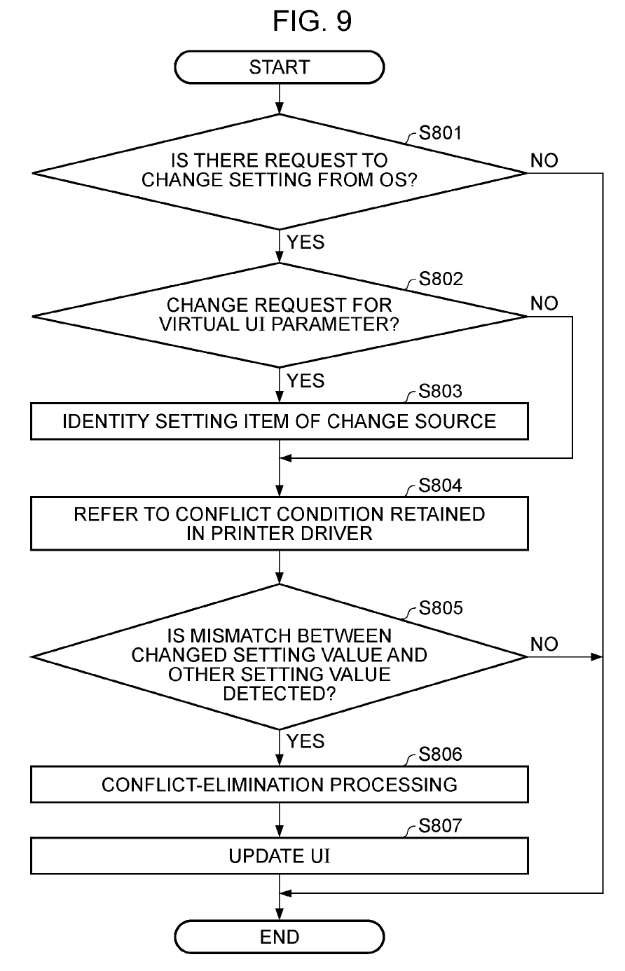

In a host computer 101 shown in FIG. 1, a central processing unit (CPU) 102 controls each of units based on programs stored in a random access memory (RAM) 104 and external storage 105. The CPU 102 loads a printer driver (print-control program) operating based on a flowchart shown in FIG. 9 which will be described later, the printer driver being provided for a printer 112, into the RAM 104 and executes the printer driver, and executes processing procedures as below. For example, the printer driver converts output information generated based on an application program into an output command ready for the printer 112.

Further, the CPU 102 executes the installed printer driver and outputs the generated output information to the printer 112 via a communication I/F 111 based on a predetermined protocol.

A read only memory (ROM) 103 stores a basic input/output system (BIOS) program executed by the CPU 102 and/or font data. The RAM 104 is used, as required, when the CPU 102 reads and/or writes data. When the printer driver is started, the program code of the printer driver is loaded onto the RAM 104.

The external storage 105 is a device that stores the program code read by the CPU 102 and attains part of the functions of the first embodiment. The external storage 105 includes a floppy disk (FD), a compact disk (CD)-rewritable (RW), a hard disk drive (HDD), and so forth. Further, the external storage 105 may be configured as a combination of the FD, the CD-RW, the HDD, a universal serial bus (USB) memory, and a secure digital (SD) memory.

An input-device-control unit 106 controls an input device 108 including a keyboard, a mouse, and so forth. Here, a user can input a numerical value and/or place a checkmark for a print setting item provided on a user interface shown on a display device 109, such as a print setting screen, by operating the input device 108.

A display-device-control unit 107 controls information displayed on the display device 109 including a cathode-ray tube (CRT), a liquid-crystal display, and so forth.

Here, a touch panel provided on the display screen of the display device 109 often functions as the input device 108.

An internal bus 110 includes a data bus provided to perform data communications between components and a system bus. A communication I/F 111 is provided to establish communications between the host computer 101 and the printer 112 and capable of performing bidirectional communications.

Here, at least two types of serial interfaces including a USB, an Institute of Electrical and Electronic Engineers (IEEE) 1394, and so forth may be used, and at least two types of parallel interfaces including a centronics interface, a small computer system interface (SCSI), and so forth may be used. However, any interface may be used so long as the interface can achieve the bidirectional communications.

In the printer 112 shown in FIG. 1, a print controller 114 controls a printer engine 115 and performs printing based on a printer command obtained from a communication I/F 113. The printer engine 115 includes a mechanism provided to operate a printer head and/or transport a recording medium.

In the first embodiment, a printing system operating on the host computer 101 is provided as Common UNIX® Printing System (CUPS) operating on Mac OS® X of Apple Inc., for example.

Here, according to the CUPS printing system operating on Mac OS® X, conditions of conflicts occurring between setting items are described in the form of UI Constraints in the above-described PPD file in which functions unique to the printer and/or settable choices are described. Consequently, the OS eliminates the conflicts occurring between the setting items by referring to the UI Constraints.

More specifically, the UI Constraints exemplarily show paperfeed methods and the sheet types. For example, if “front tray” is selected as the paperfeed method and envelope is selected as the sheet type, a paper jam may occur and cause damage to the printer 112. In that case, the combination of the paperfeed method “front tray” and the sheet type “envelope” may be prohibited on the user interface, so as to reduce the above-described damage.

Thus, according to the above-described OS, the UI Constraints allow for prohibiting the combination of two setting items. The above-described example can be described as “*UIConstraints *MediaType envelop *MediaSupply front”.

Thus, the UI Constraints are described so that the paperfeed method “front tray” is set. At that time, when the user exemplarily selects the sheet type “envelope” as the print setting item by operating the input device 108, the OS performs the conflict processing as below.

Here, the OS evaluates the conflict occurring between the setting items based on the UI Constraints described in the PPD file, and converts data on the paperfeed method “front tray”, which is the above-described print setting item, into an unselectable value. The printer driver is notified of the value converted by the OS in the above-described manner. Therefore, the printer driver can update the UI based on the value obtained through the notification. The above-described procedures are examples performed to eliminate a conflict occurring between a single print setting item and another single print setting item.

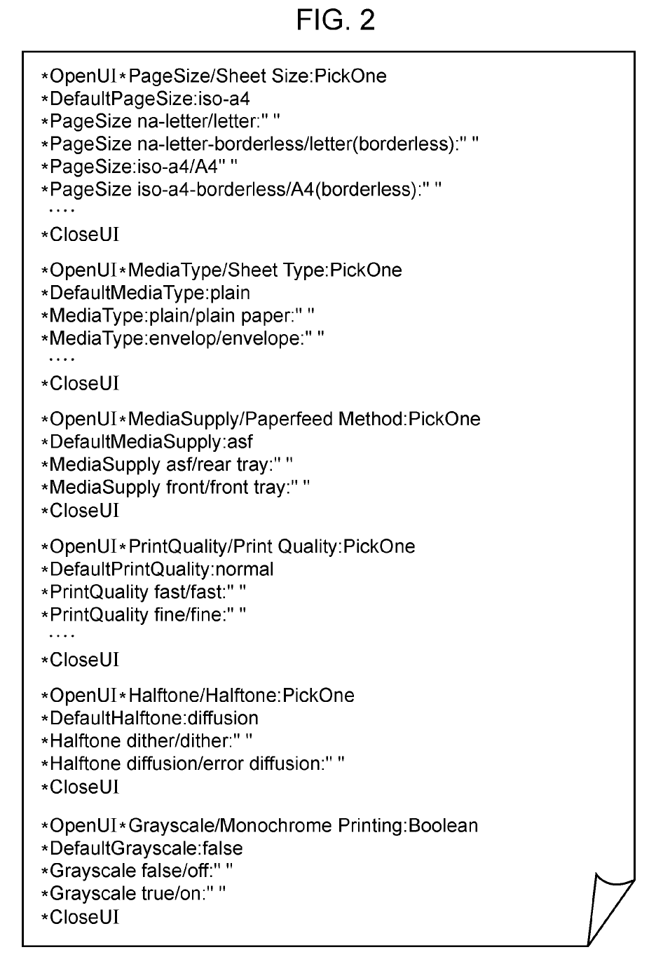

FIG. 2 shows an exemplary PPD file stored in the external storage 105 shown in FIG. 1.

As shown in FIG. 2, the PPD file is a file in which data on functions unique to the printer and settable choices is described.

According to the PPD file shown in FIG. 2, settable choices, default values, display character strings are examples described for the individual print setting items.

Here, the print setting items include the sheet size (PageSize), the sheet type (MediaType), the paperfeed method (MediaSupply). Similarly, the print setting items include the print quality (PrintQuality), halftone (Halftone), and monochrome printing (Grayscale).

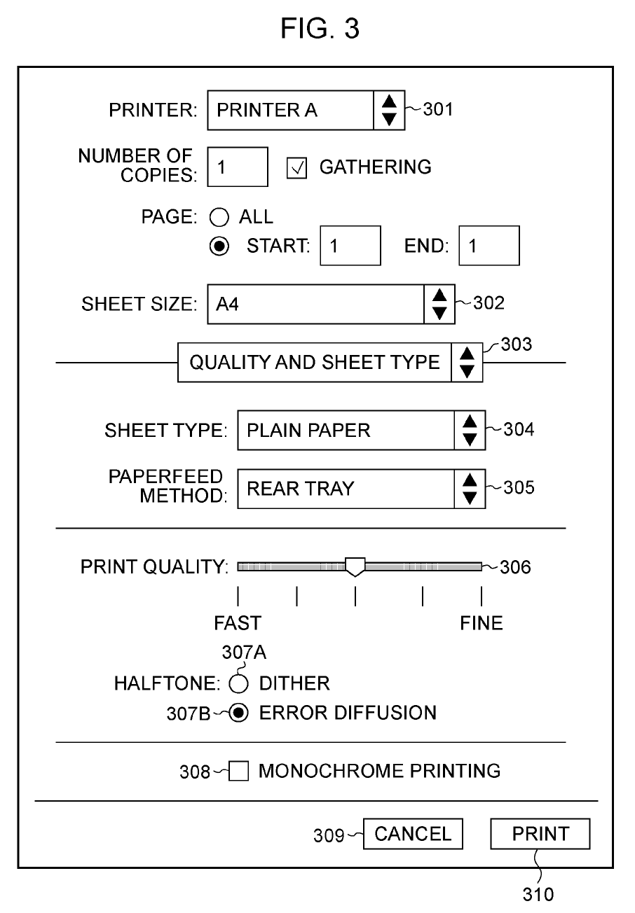

FIG. 3 shows an exemplary print dialog box presented by the printer driver installed in the external storage 105 shown in FIG. 1. On the print dialogue, the print setting items managed by the OS and those managed by the printer driver are displayed at the same time.

Further, the controls corresponding to the individual print setting items described in the PPD file shown in FIG. 2 are provided on the print dialog box shown in FIG. 3. The print dialog box is called from an arbitrary application installed in the external storage 105 via the OS at the print setting time, and displayed on the display device 109 including a monitor or the like shown in FIG. 1.

When the user selects an arbitrary application from an application menu or the like by operating the input device 108, the arbitrary application is started. Further, when applications registered with a start folder including a start-up file or the like are installed, at least one of the registered applications is often started at the same time as when the power is turned on.

According to FIG. 3, a popup menu 301 is provided to allow the user to select a printer for outputting data by operating the device 108. FIG. 3 shows the current state where the user selects the printer corresponding to the printer name “printer A” by operating the input device 108.

A popup menu 302 is provided to allow the user to select the sheet size, which is the print setting item, by operating the input device 108. Here, the popup menus 301 and 302 are managed on the OS side and are not displayed through the printer driver. From now on, menus displayed through the printer driver will be described.

A popup menu 303, which shows “quality and sheet type”, “color option”, and so forth, corresponds to a main menu provided to allow the user to change the setting screen. FIG. 3 shows the state in which “quality and sheet type” is selected by the user operating the input device 108.

A popup menu 304 is provided to allow the user to select the sheet type, which is the print setting item. A popup menu 305 is provided to allow the user to select the paperfeed method, which is the print setting item.

A slide bar 306 is provided to allow the user to select the print quality, which is the print setting item, on a 1-to-5 scale, for example.

Radio buttons 307A and 307B are provided to allow the user to select a halftone for use, which is the print setting item. For example, the radio buttons 307A and 307B allow the user to select either “dither” or “error diffusion”, for example.

A check box 308 is exemplarily provided to allow the user to determine whether monochrome printing, which is shown as the print setting item, should be performed.

Here, the drop down menus 303, 304, and 305, the slide bar 306, the radio buttons 307A and 307B, and the check box 308 are the print setting items managed on the printer-driver side. The printer driver also manages the layout of the entire dialogue, including whether the menus should be displayed or not, the arrangement of the buttons, and so forth.

When a cancel button 309 is pressed in accordance with an operation performed by the user, the print dialog box shown in FIG. 3 is closed by the printer driver and the values set by the user for the individual print setting items are cancelled.

When a print button 310 is pressed, the values set by the user for the individual print setting items provided on the print dialog box shown in FIG. 3 are determined, and the print dialog box is closed.

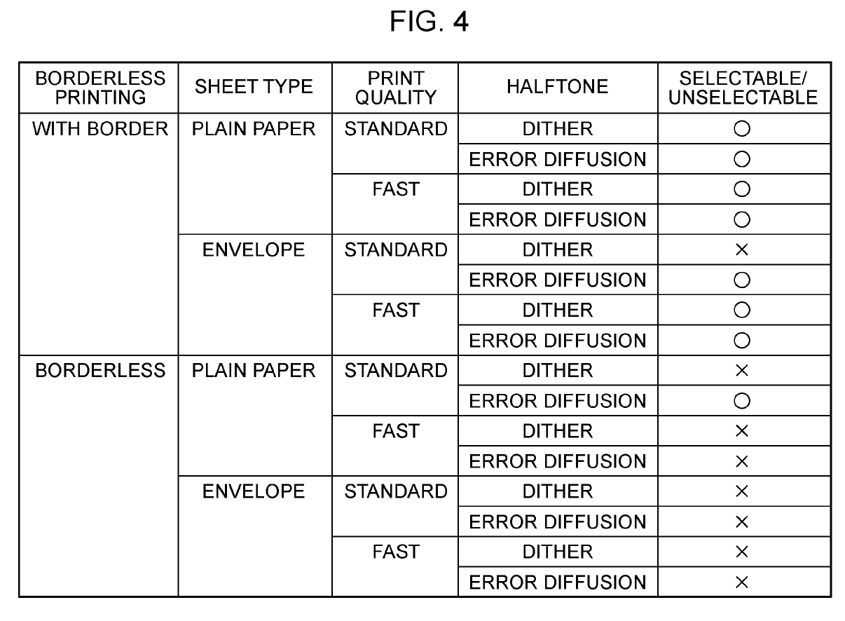

FIG. 4 shows part of the rules of selectable/unselectable combinations of the print setting items provided on the print dialog box shown in FIG. 3 (the conflict rules).

The printer driver should control the display status of the print setting items by the above-described conflict rules, so as not to allow the user to select incompatible combinations on the print dialog box shown in FIG. 3.

For example, when “borderless printing: with border”+“sheet type: envelope”+“print quality: standard” are selected, for example, as the print setting items, the printer driver performs the display control as below. More specifically, the printer driver should gray out only the part showing “dither” of the radio button 307A for display (unselectable state), so that the print setting item “halftone: dither” is not selected.

Further, when “borderless printing: without border”+“sheet type: plain paper” are selected as the print setting items, the printer driver performs the display control as below. More specifically, the printer driver should gray out the position corresponding to “print quality: fast” for display on the slide bar 306 provided to indicate the print quality.

The above-described conflict processing procedures are so complicated that providing the above-described UI Constraints capable of prohibiting the combination of two print setting items is inadequate to achieve the conflict processing procedures.

However, if all of the print setting items can be handled in the printer driver, the use of the UI Constraints becomes unnecessary, so that the above-described problem does not occur.

In actuality, however, there are print setting items managed on the OS side on the print dialog box, such as the popup menu 302 functioning as the sheet size menu.

Here, the print setting items managed on the printer-driver side may have exclusion relations and/or dependence relations with the print setting items managed on the OS side.

When the above-described print setting items have the exclusion relations and/or the dependence relations with each other, it is difficult for the printer driver to receive a notification that the setting value of the print setting item managed on the OS side is changed unless the UI Constraints are described.

Namely, when the print setting items managed on the OS side have some relations with those managed on the printer-driver side, the UI Constraints should be described.

Therefore, the above-described embodiment provides parameters designed specifically for making the OS notify the print driver that the setting value is changed when the print setting item managed on the OS side is changed.

The above-described specifically designed parameters are characteristic UI parameters provided in the above-described embodiment. The UI parameters do not directly correspond to the print setting items provided on the above-described print dialog box shown in FIG. 3. Hereinafter, therefore, an example of the above-described specifically designed UI parameters will be referred to as virtual UI parameters. Further, in the above-described embodiment, when one of the print setting items provided on the print dialog box is set in accordance with an operation performed by the user, parameter-notification processing which will be described later is performed between the OS and the printer driver.

On the other hand, parameters corresponding to the individual print setting items shown on the print dialog box on a one-to-one basis are referred to as virtual UI parameters.

Upon receiving a notification that there is a change in the virtual UI parameters from the OS, the printer driver can determine that the print setting item managed on the OS side is changed, and eliminate a conflict on the printer-driver side. In that case, the printer driver determines the change state of the virtual UI parameters, the change state being obtained through the notification transmitted from the OS, identifies two or more print setting items associated with a single virtual UI parameter, and uses the conflict rules shown in FIG. 4 for the print setting items. Then, the printer driver eliminates a conflict that can occur between the print setting items by the conflict rules shown in FIG. 4, and performs control, so as to update the display state of the setting value of the changed print setting item. Here, the display state includes the state in which a predetermined print setting item is grayed out for display, so as to make it difficult for the user to select the predetermined print setting item.

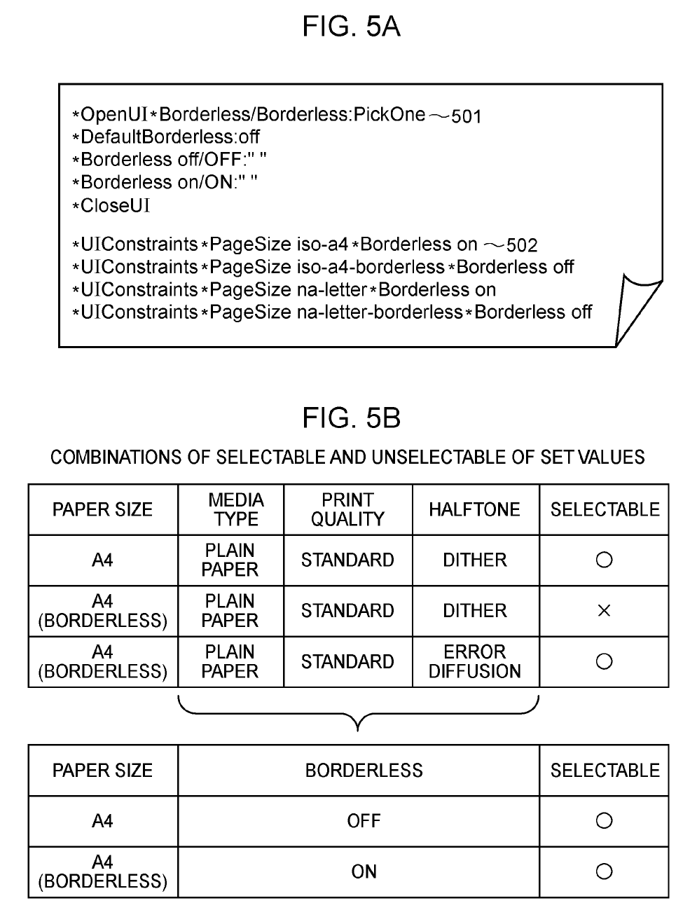

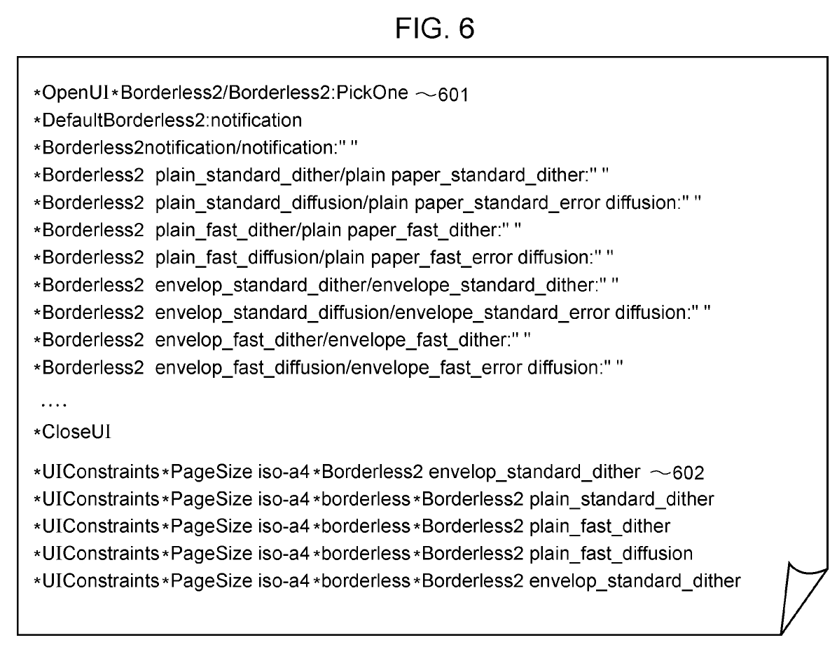

Each of FIGS. 5A and 6 exemplarily shows virtual UI parameters and UI Constraints that can be referred to by the OS of the host computer 101 according to the above-described embodiment. Here, the virtual UI parameters and the UI Constraints are appended to the PPD file shown in FIG. 2 for use.

In FIG. 5A, virtual UI parameters 501 are defined by the name “Borderless”. The “Borderless” allows for setting binary values “off” and “on”.

In the above-described embodiment, the values that can be set by the “Borderless” are determined to be binary. Consequently, when the margin of the sheet size (with/without border) is changed on the popup menu 302 functioning as the menu of sheet sizes, which are the print setting items managed on the OS side, it becomes possible to receive a notification that a change is made so that “borderless printing” is performed from the OS, as shown in FIG. 5B. Thus, the conflict can be eliminated by the conflict rules shown in FIG. 4.

FIG. 5B shows an exemplary table showing the pros and cons of selections of the print setting items managed by the printer driver, the selections being made for the sheet sizes, that is, A4, A4 (without border), and A4 (without border), which are the print setting items managed by the OS.

In the above-described embodiment, the print setting items managed by the printer driver are shown as the sheet type, the print quality, and the halftone, for example. Here, the above-described print setting items have dependence relations with one another.

The virtual UI parameter “Borderless” shown in FIG. 5B functions as a single parameter which is the integration of the print setting items “sheet type”, “print quality”, and “halftone” that are managed by the printer driver.

On the other hand, the method of describing the UI Constraints in the PPD file can be used, as it is, on the OS side. That is to say, according to the UI Constraints description method, the virtual UI parameter “Borderless” is described for the print setting items “PageSize” so that one-to-one relations are established therebetween.

Here, the virtual UI parameter is an internal parameter that does not directly correspond to the print dialog box shown in FIG. 3. Therefore, upon receiving information indicating the change state of the virtual UI parameter, the information being transmitted from the OS, the printer driver performs processing, so as to determine to which of the UI parameters the virtual UI parameter corresponds, as described later.

Further, in FIG. 5B, the part where OFF and ON are described is a part where character strings shown on the print dialog box are described. In the above-described embodiment, the character string has the same meaning as that of the setting value, so as to allow the user to understand the meaning of the setting value.

In FIG. 5A, UI Constraints 502 are exemplarily described, so as to indicate that the combination of the UI parameter (PageSize) and the virtual UI parameter (Borderless) is prohibited.

Operations performed to achieve the above-described prohibition will be specifically described as below. For example, when the print setting item “A4” is changed to the print setting item “A4 (without border)” on the sheet-size menu 303 in the state where the print setting item “Borderless printing: with border” (Borderless—off) is set, the OS refers to the UI Constraints described as below and detects the occurrence of a conflict.

When the printer driver is installed, data of the UI Constraints is stored in a system file area of the external storage 105, as a file referred to by the OS.

The OS refers to “*UIConstraints*PageSize iso-a4-borderless*Borderless off” corresponding to the second line of the UI Constraints 502 shown in FIG. 5A.

When the OS detects the conflict occurrence based on the description of the above-described UI Constraints, the OS performs processing procedures as below. More specifically, the OS changes the setting value “off” of the virtual UI parameter (Borderless) to the settable value “on”, and notifies the printer driver of a value (Borderless—on) obtained after the change.

Thus, when there is a change in the details of “without/with border” of the print setting item “sheet size” managed by the OS, the virtual UI parameter (Borderless) functions so that the OS issues a notification without fail irrespective of whether the conflict should be eliminated on the printer-driver side.

However, in the case where the virtual UI parameter (Borderless) shown in FIG. 5A is provided, the notification is issued without fail even though the reception of the notification is unnecessary in reality (no conflict occurs between the current setting value and the changed sheet size).

Accordingly, FIG. 6 shows what is obtained after improving the notification function of the virtual UI parameters shown in FIGS. 5A and 5B.

More specifically, FIG. 6 shows exemplary UI Constraints and exemplary virtual UI parameters defined so that no notification is issued in the case where no conflict occurs between the setting value of the print setting item managed on the OS side and that of the print setting item managed by the currently used printer driver even though details of the print setting item “sheet size” managed on the OS side are changed.

In FIG. 6, a virtual UI parameter 601 is defined as the name “Borderless2”. Data of the Borderless2 is stored in the system file area of the external storage 105, as is the case with the UI Constraints.

The parameter “Borderless2” has the combinations of all of the setting values shown in FIG. 4, as settable choices.

Further, in the above-described embodiment, the default value is defined as “notification” as a matter of convenience. The notification of the default value is issued when the conflict should be eliminated on the printer-driver side.

The print setting items exemplarily set for the parameter “Borderless2” will be described as below. For example, when the print setting items “sheet type: plain paper”+“print quality: standard”+“halftone: error diffusion” are selected on the UI of the printer driver, the printer driver performs the following processing procedures. More specifically, the printer driver sets “plain_standard_diffusion” to the parameter “Borderless2”.

Then, if the user changes the print setting item “halftone: error diffusion” managed on the printer-driver side to the print setting item “halftone: dither”, the printer driver sets “plain_standard_dither” to the parameter “Borderless2”.

According to the description of UI Constraints 602, the combination of the UI parameter (PageSize) and the virtual UI parameter (Borderless2) is prohibited.

Operations performed to achieve the above-described prohibition will be specifically described as below. For example, when the print setting item “A4” is changed to the print setting item “A4 (without border)” on the sheet-size menu 303 in the state where the print setting items “sheet type: plain paper”+“print quality: standard”+“halftone: dither” (Borderless2-plain_standard_dither) are exemplarily set, the OS refers to the UI Constraints described as below and detects the occurrence of a conflict.

The OS refers to “*UIConstraints *PageSize iso-a4-borderless *Borderless2 plain_standard_dither”, as the UI Constraints.

When the print setting item “A4” is changed to the print setting item “A4 (without border)” on the sheet-size menu 303 by the user operating the input device 108 on the print dialog box, the OS detects the conflict occurrence, and performs the following processing procedures.

The OS changes the setting value “plain_standard_dither” of the Borderless2 into the default value “notification”. Then, the OS notifies the printer driver of the value “Borderless2-notification”, as a value obtained after the change.

The difference between the virtual UI parameter (Borderless) shown in FIG. 5A and the virtual UI parameter (Borderless2) shown in FIG. 6 is shown as below.

For example, when the print setting item “A4” is changed to the print setting item “A4 (without border)” on the sheet-size menu 303 in the state where the print setting items “sheet type: plain paper”+“print quality: standard”+“halftone: error diffusion” (Borderless2-plain_standard_diffusion) are set, the OS does not issue the notification.

On the other hand, according to the virtual UI parameter (Borderless) shown in FIG. 5A, the notification is issued from the OS without fail as described above when the print setting item “A4” is changed to the print setting item “A4 (without border)” on the sheet-size menu 303, and meaningless conflict elimination processing is performed.

Thus, the virtual UI parameter Borderless2 shown in FIG. 6 has the following characteristics. The above-described parameter defines that the notification is transmitted from the OS only when a conflict should be eliminated on the printer-driver side in the case where the sheet size, which is the print setting item managed on the OS side, is changed as to whether the margin should be provided.

Therefore, the printer driver can perform the conflict elimination processing with efficiency without receiving an unnecessary notification transmitted from the OS.

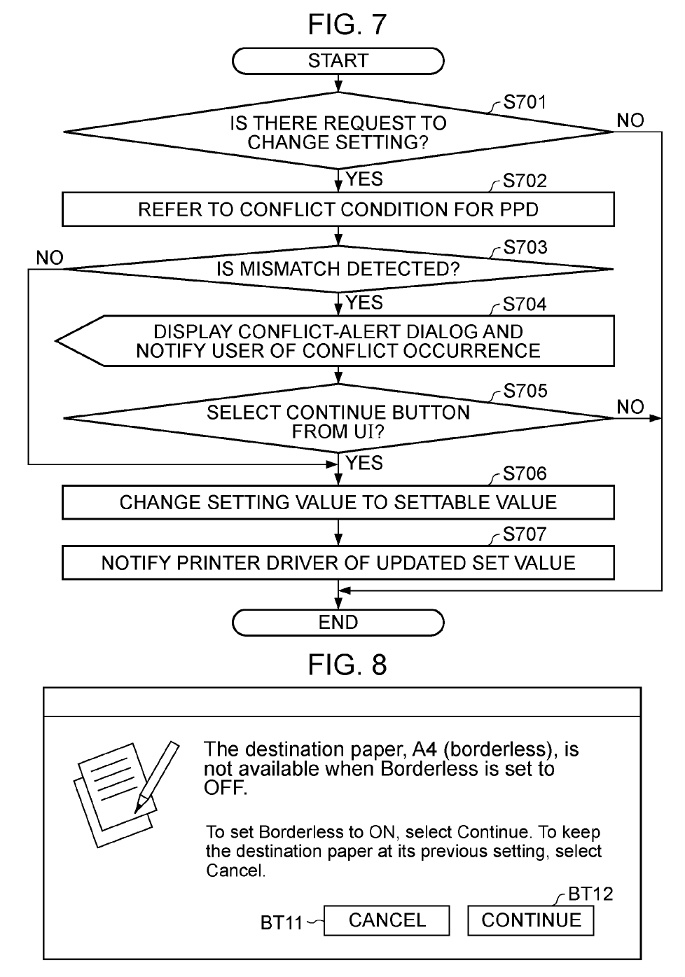

FIG. 7 is a flowchart showing the first exemplary data processing procedures performed in the host computer 101 according to the above-described embodiment. The first exemplary data processing procedures are performed to eliminate a conflict of the OS. The CPU 102 loads the OS from the external storage 105 into the RAM 104 and executes the operating system so that each of steps S701, S702, S703, S704, S705, S706, and S707 is achieved.

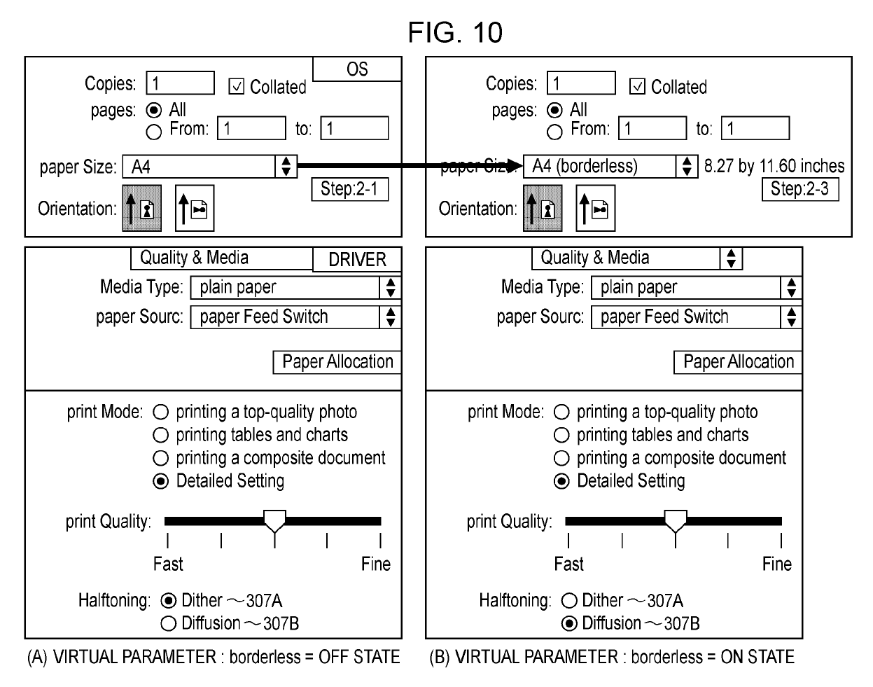

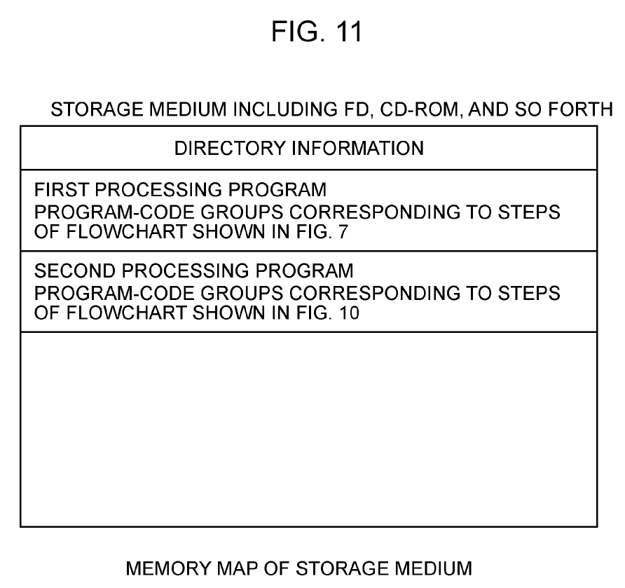

Hereinafter, the above-described processing procedures will be descried with reference to user interfaces shown in FIGS. 8 and 10.

Each of FIGS. 8 and 10 shows an exemplary print dialog box shown on the display device 109 shown in FIG. 1. The dialog shown in FIG. 8 is displayed when the sheet size (PaperSize) shown in Part (A) of FIG. 10, which is the print setting item managed on the OS side, is changed from “A4” to “A4 (borderless)”.

The user interface shown in Part (A) of FIG. 10 corresponds to when the virtual UI parameter is in the “OFF” state and that shown in Part (B) of FIG. 10 corresponds to when the virtual UI parameter is in the “ON” state. Further, each of radio buttons 307A and 307B is provided to choose the method of halftoning. Here, the radio button 307A is selected when “Dither” is selected as the halftoning method, which is the print setting item managed on the printer-driver side.

Further, the radio button 307B is selected when “Error Diffusion” is selected as the halftoning method, which is the print setting item managed on the printer-driver side.

At step S701, the CPU 102 determines whether a request to change the print setting item managed on the OS side of the print setting items provided on the print dialog box shown on the display device 109 is accepted through an operation performed by the user. If the CPU 102 determines that the above-described request is not accepted through the operation performed by the user, the above-described processing is terminated.

On the other hand, if the CPU 102 determines that the above-described request is accepted through the operation performed by the user at step S701, the above-described processing advances to step S702.

Then, at step S702, the CPU 102 refers to the UI Constraints described in the PPD file shown in FIG. 5A. Then, at step S703, the CPU 102 determines whether it is difficult to set a setting value obtained by changing the print setting item for which the change request is issued. Namely, the CPU 102 determines whether the occurrence of a mismatch (conflict) is detected.

If the CPU 102 determines that no mismatch is detected, the processing advances to step S706. Otherwise, the processing advances to step S704.

If the CPU 102 determines that some conflict occurs between the changed setting value and at least one other setting value, at step S703, the processing advances to step S704. Then, at step S704, the CPU 102 shows a dialog designed to notify the user of a conflict alert shown in FIG. 8 on the display device 109 so that the user is notified that a conflict occurs due to the print setting item “A4 (borderless)” selected by the user.

Buttons BT11 and BT12 are provided on the dialog shown in FIG. 8. When the user issues an instruction to press the button BT12 by operating the input device 108, the CPU 102 issues an instruction to retain the selection of the print setting item “A4 (borderless)” in response to a message shown on the dialog shown in FIG. 8.

On the other hand, if the user issues an instruction to press the button BT11 by operating the input device 108, the CPU 102 issues an instruction to cancel the selection of the print setting item “A4 (borderless)” in response to the message shown on the dialog shown in FIG. 8.

Further, the dialog shown in FIG. 8 is displayed on the display device 109 at the time when the print setting item “A4 (borderless)” is selected from a spin box shown in Part (A) of FIG. 10, as the sheet size, which is the print setting item managed on the OS side. Although the language used in the above-described embodiment is English, the dialog is displayed, as text prepared in the language corresponding to the destination of the printer.

Next, at step S705, the CPU 102 determines which of the buttons BT11 and BT12 is pressed in response to the dialog shown in FIG. 8. The user presses the button BT12 in response to the dialog shown in FIG. 8, so as to permit to change the other setting value for which a conflict occurs due to the setting value for which the change request is issued at step S701.

Then, if the CPU 102 determines that the button BT12 is pressed, the CPU 102 further determines that the user requests that the processing performed based on the selection of the print setting item “A4 (borderless)” be continued, and advances to step S706.

On the other hand, if the CPU 102 determines that the button BT11 is pressed, at step S705, the CPU 102 further determines that the user requests that the processing performed based on the selection of the print setting item “A4 (borderless)” be cancelled, and terminates the above-described processing.

Then, at step S706, the CPU 102 changes the setting value of the sheet size or the like corresponding to the print setting item for which the conflict occurs due to the OS, the print setting item being managed on the OS side to a settable value.

The above-described settable value denotes a default value described in the PPD file shown in FIG. 6. Otherwise, if there are binary settable values alone, as is the case with the UI Constraints file of the PPD file shown in FIGS. 5A and 5B, one of the binary settable values is determined to be the settable value.

Next, at step S707, the CPU 102 notifies the printer driver of the changed value through the OS and terminates the above-described processing. Here, if the state of the virtual UI parameter is changed from the OFF state to the ON state, as the print setting item managed on the OS side through an operation performed by the user, the OS notifies the printer driver of the virtual UI parameter and the changed value.

If a conflict occurs between the virtual UI parameter and the changed value, as shown in the PPD file shown in FIGS. 5A, 5B, and 6, the OS notifies the printer driver of the virtual UI parameter.

FIG. 9 is a flowchart showing the second exemplary data processing procedures performed in the host computer 101 according to the above-described embodiment. The second exemplary data processing procedures are performed to eliminate a conflict of the print driver. The CPU 102 loads the printer driver from the external storage 105 into the RAM 104 and executes the printer driver so that each of steps S801, S802, S803, S804, S805, S806, and S807 is performed.

At step S801, the CPU 102 executes the printer driver so that the print setting value managed on the OS side is changed, so as to determine whether a request to change the print setting value is transmitted from the OS to the printer driver. Here, the printer driver also determines whether at least one of the print setting values managed on the printer-driver side of the print setting items provided on the print dialog box shown in FIG. 8 is changed.

Then, if the CPU 102 determines that no request to change the setting value in accordance with the change in the print setting value managed on the OS side is transmitted from the OS to the printer driver by executing the printer driver at step S801, the CPU 102 terminates the above-described processing.

On the other hand, if the CPU 102 determines that the request to change the setting value in accordance with the change in the print setting value managed on the OS side is transmitted from the OS to the printer driver by executing the printer driver at step S801, the CPU 102 advances to step S802.

Then, at step S802, the CPU 102 executes the printer driver, so as to determine whether the change in the setting value, where the OS notifies the printer driver of the change, is the virtual UI parameter.

Here, according to an exemplary method of making the above-described determination, data of a table or the like showing the list of the virtual UI parameters may be stored in a table area to which the printer driver refers so that the printer driver can refer to the table. However, any method may be used so long as the method allows for determining the virtual UI parameter. Further, the table area to which the printer driver refers is allocated in the external storage 105, and data of the table area is stored in a specified table area when the printer driver is installed in the external storage 105. At that time, data of the UI Constraints corresponding to the virtual UI parameter is stored in a system area referred to by the OS, as the PPD file.

Consequently, the virtual UI parameter can be transferred between the printer-driver side and the OS side with favorable matching.

Next, if the CPU 102 determines that the setting-value-change request transmitted from the OS to the printer driver is a request to change the virtual UI parameter by executing the printer driver at step S802, the CPU 102 identifies the setting value of the change source of the virtual UI parameter obtained through the notification transmitted from the OS at step S803.

According to an exemplary method of identifying the setting value of the change source, data of a table or the like describing the relationship between the virtual UI parameter and the setting value of the change source may be stored in the external storage 105 for reference. Otherwise, the printer driver may directly refer to the UI Constraints described in the PPD file of which data is stored in the system file of the OS so that the change source is identified.

If the CPU 102 determines that the setting-value-change request transmitted from the OS to the printer driver is not the request to change the virtual UI parameter at step S802, the CPU 102 omits step S803 and advances to step S804.

Then, at step S804, the CPU 102 refers to the conflict rules shown in FIG. 4, so as to detect a conflict occurring between the setting value of the identified change source and the changed setting value.

Then, at step S805, the CPU 102 determines whether some conflict occurring between the changed setting value and at least one other setting value is detected. If the CPU 102 determines that the above-described conflict does not occur, the CPU 102 terminates the above-described processing.

On the other hand, if the CPU 102 determines that the above-described conflict occurs at step S805, the printer driver refers to a conflict condition generated by the conflict rules shown in FIG. 4 and performs the conflict elimination processing (S806). More specifically, the CPU 102 compares the details of the change in the setting state of the virtual UI parameter with the conflict rules through the printer driver. Then, the CPU 102 identifies a print setting item determined not to be selected by the user from among the print setting items that can be set on the print dialog box based on the comparison result.

After completing the conflict elimination processing, the CPU 102 advances to step S807. Since the setting value of the print setting item managed on the OS side is changed through the printer driver, the CPU 102 updates the printer-driver UI at step S807, as shown in Part (B) of FIG. 10, and terminates the above-described processing.

The above-described print setting items are provided as exemplary print settings.

The host computer 101 is provided to communicate with the printer 102, which is an exemplary printer, and make print settings of the printer driver. The CPU 102 eliminates the conflict state caused between a plurality of print settings by executing the printer driver based on the state of the parameters associated with the plurality of print settings set for the print driver and the conflict conditions that can define two print settings, the conflict condition being set in advance for the print settings.

The UI Constraints are provided as an exemplary conflict condition that can define the two print settings. Further, the virtual UI parameter is provided as an example of the parameters associated with the plurality of print settings set for the printer driver.

Here, the print setting item “sheet size”, that is, “paper Size” shown in Part (A) of FIG. 10 is changed to the print setting item “A4 (borderless)”, so that the printer driver performs the following display control. More specifically, the printer driver updates the display state so that the display state where the radio button 307A is shown is changed to the display state where the radio button 307B is selected, as shown in Part (B) of FIG. 10, where the radio buttons 307A and 307B are provided for the print setting item “Halftoning”, which is managed on the printer-driver side, having the exclusion relation with the print setting items managed on the OS side.

As described above, in the above-described embodiment, the virtual UI parameter is described in the PPD file managed on the OS side when the UI Constraints are described in the PPD file and the OS notifies the printer driver of the virtual UI parameter. Consequently, it becomes possible to associate a plurality of the print setting items with the UI Constraints so that a one-to-two or more relation is established between the print setting items and the UI Constraints, where the UI Constraints are originally described so that a one-to-one relation is established.

Consequently, even though the print setting item managed on the printer-driver side has the exclusion relation and/or the dependence relation with the print setting item managed on the OS side, the present invention can be used without changing the structure of the PPD file provided on the OS side.

Further, the above-described embodiment allows for describing a complicated combination of three or more print setting items, the combination being described with difficulty through UI Constraints described in a known PPD file, by using the virtual UI parameter. Consequently, it becomes possible to notify the printer driver of a conflict by using the virtual UI parameter described in the UI Constraints and eliminate the conflict.

In the above-described embodiment, the OS notifies the printer driver of the change in the virtual UI parameter. However, the same advantage as that of the above-described embodiment can be attained by notifying the printer driver of the parameters corresponding to two or more print setting items for the case where a single print setting item is set by a module other than the OS.

Hereinafter, the configuration of a data processing program that can be read by the host computer 101 according to a second embodiment of the present invention will be described with reference to a memory map shown in FIG. 11.

FIG. 11 illustrates the memory map of a storage medium storing various types of data processing programs that can be read by the host computer 101 according to the second embodiment of the present invention.

Information provided to manage a group of programs stored in the storage medium, the information including version information, data of the producers, and so forth, is often stored in the storage medium, though not shown. Further, information depending on an OS or the like provided on the program-read side, such as information about an icon or the like provided to identify and display the program, may be stored in the storage medium.

Further, data dependent on the various programs is also managed by the above-described directory. Further, a program provided to install the various programs in a computer, a program provided to decompress a program for installation when the program for installation is compressed, and so forth may also be stored in the storage medium.

The functions of the above-described embodiment, which are shown in FIGS. 7 and 10, may be executed by the host computer 101 through an externally installed program. In that case, the present invention can be used even though a group of information items including a program is supplied from a storage medium including a CD-read-only memory (ROM), a flash memory, an FD, and so forth, and/or an external storage memory to an output apparatus via a network.

It is to be understood that the object of the present invention can also be achieved by supplying a storage medium storing program code of software for implementing the functions of the above-described embodiments to a system and/or an apparatus so that a computer (or a CPU and/or a microprocessing unit (MPU)) of the system and/or the apparatus reads and executes the program code stored in the storage medium.

In that case, the program code itself, read from the storage medium, achieves new functions of the present invention, and thus the storage medium storing the program code constitutes an embodiment of the present invention.

Consequently, the program code may be provided in any form. For example, the program code may be object code, a program executed by an interpreter, script data supplied to an OS, and so forth, as long as they have the functions of the program code.

The storage medium for providing the program code may be, for example, a flexible disk, a hard disk, an optical disk, a magneto-optical (MO) disk, a CD-ROM, a CD-recordable (R), a CD-rewritable (RW), a magnetic tape, a nonvolatile memory card, a ROM, a digital versatile disk (DVD), and so forth.

In that case, the program code itself read from the storage medium achieves the functions of the above-described embodiments, and thus the storage medium storing the program code constitutes the present invention.

Further, the program may be supplied in the following methods. For example, a user accesses a home page established on the Internet by using a browser of a client computer. Then, the user downloads the computer program itself of the present invention from the home page and/or compressed file data including data on an automatic-install function to a recording medium such as a hard disk. Further, the program can be supplied by dividing program code generating the program of the present invention into plural file-data items and downloading the file-data items from different home pages. Namely, a WWW server, an ftp server, and so forth that are provided to download program-file-data items used to achieve the functional processing of the present invention by using a computer to plural users are also included in the following claims of the present invention.

Further, the program of the present invention may be encoded and stored in storage mediums such as CD-ROMs distributed to users. Then, key information used to decode the encoded program may be downloaded from the home page to a user satisfying predetermined conditions via the Internet. Through the use of the downloaded key information, the encoded program can be executed and installed in a computer so that the program is supplied to the system and/or the apparatus.

Further, not only by the computer reading and executing the read program code, but also by the computer executing part of or the entire process utilizing an OS, etc. running on the computer based on instructions of the program, the functions of the above-described embodiments may be achieved.

Further, the program read from the recording medium may be written into a memory of a function-expansion board inserted into the computer and/or a function-expansion unit connected to the computer. Then, a CPU or the like of the function-expansion board and/or the function-expansion unit may execute part of or the entire process based on instructions of the program so that the functions of the above-described embodiments are achieved.

While the present invention has been described with reference to exemplary embodiments, it is to be understood that the invention is not limited to the disclosed exemplary embodiments by a person or persons skilled in the art. Namely, the scope of the following claims is to be accorded the broadest interpretation so as to encompass all modifications (including organic combinations of the embodiments) and equivalent structures and functions.

This application claims the benefit of Japanese Patent Application No. 2008-003269 filed on Jan. 10, 2008, which is hereby incorporated by reference herein in its entirety.

What is claimed is:

1. An information processing apparatus that communicates with a printer and makes print settings of a printer driver, the information processing apparatus comprising:
an elimination unit configured to eliminate a conflict state occurring between a plurality of print settings set for the printer driver, based on a state of at least one parameter associated with the plurality of print settings and a conflict condition which can define two print settings, wherein the conflict condition is set for the plurality of print settings in advance.

2. The information processing apparatus according to claim 1, further comprising an update unit configured to update a display of print settings that should be displayed through a user interface of the printer driver based on the print settings for which the conflict state is eliminated by the elimination unit.

3. The information processing apparatus according to claim 1, wherein the parameter is used when the printer driver notifies an operating system that a plurality of print settings is changed for a single print setting.

4. The information processing apparatus according to claim 1, wherein the conflict condition is managed by an operating system,
the information processing apparatus further comprising:
a dialog box display unit configured to display a dialog box provided to ask a user whether the operating system should notify the printer driver of a change in the parameter; and
a determining unit configured to determine whether the user issues a request to notify the printer driver of the parameter in response to the displayed dialog box,
wherein, when the determining unit determines that the user issues the request, the operating system notifies the printer driver of a setting state of a parameter associated with a plurality of print settings managed by the printer driver.

5. The information processing apparatus according to claim 4, wherein, when the determining unit determines that the user does not issue the request to notify the printer driver of the parameter, the operating system notifies the printer driver of a default setting, as the setting state of the parameter associated with the plurality of print settings managed by the printer driver.

6. A print setting method used for an information processing apparatus that communicates with a printer and makes print settings of a printer driver, the print setting method comprising:
eliminating a conflict state occurring between a plurality of print settings set for the printer driver, based on a state of at least one parameter associated with the plurality of print settings and a conflict condition which can define two print settings, wherein the conflict condition is set for the plurality of print settings in advance.

7. The print setting method according to claim 6, further comprising updating a display of print settings that should be displayed through a user interface of the printer driver based on the print settings for which the conflict state is eliminated.

8. The print setting method according to claim 6, wherein the parameter is used when the printer driver notifies an operating system that a plurality of print settings is changed for a single print setting.

9. The print setting method according to claim 6, wherein the conflict condition is managed by an operating system,
the print setting method further comprising:
displaying a dialog box provided to ask a user whether the operating system should notify the printer driver of a change in the parameter; and
determining whether the user issues a request to notify the printer driver of the parameter in response to the displayed dialog box,
wherein, when it is determined that the user issues the request, the operating system notifies the printer driver of a setting state of a parameter associated with a plurality of print settings managed by the printer driver.

10. The print setting method according to claim 9, wherein, when it is determined that the user does not issue the request to notify the printer driver of the parameter, the operating system notifies the printer driver of a default setting, as the setting state of the parameter associated with the plurality of print settings managed by the printer driver.

11. A computer-readable storage medium storing a program provided to make a computer execute the print setting method according to claim 6.
